(19) United States
(12) Patent Application Publication
(10) Pub. No.: US 2022/0177268 A1
(43) Pub. Date: Jun. 9, 2022

(54) ELEVATOR CONTROL INPUT DEVICE

(71) Applicant: Otis Elevator Company, Farmington, CT (US)

(72) Inventor: Efim Krasnov, Saint-Petersburg (RU)

(21) Appl. No.: 17/401,857

(22) Filed: Aug. 13, 2021

(30) Foreign Application Priority Data
Dec. 3, 2020 (RU) 2020139631

(51) Int. Cl. B66B 1/46; B66B 3/00; B66B 13/14; B66B 1/30

(52) U.S. Cl. CPC B66B 1/468; B66B 3/002; B66B 13/143; B66B 2201/103; B66B 2201/4638; B66B 2201/4615; B66B 2201/4623; B66B 1/30

(57) ABSTRACT

An elevator control input device includes at least two sensors which are configured for detecting the presence of an object, in particular a part of a human body such as a hand or a finger, within a vicinity of the respective sensor. The elevator control input device is configured for triggering a first action individually associated with the respective sensor when the object is detected to be situated closer than a first distance (d₁) but further away than a second distance (d₂) from the respective sensor; and for triggering a second action individually associated with the respective sensor when the object is detected to be situated closer than the second distance (d₂) from the respective sensor.

### FOREIGN PRIORITY

This application claims priority to Russian Patent Application No. 2020139631, filed Dec. 3, 2020, and all the benefits accruing therefrom under 35 U.S.C. § 119, the contents of which in its entirety are herein incorporated by reference.

### TECHNICAL FIELD

The invention relates to an elevator control input device, to an elevator controller comprising such an input device, and to an elevator system with an elevator controller comprising such an input device.

### BACKGROUND

An elevator system as referred to herein comprises at least one elevator car, which is configured for moving along a hoistway extending between a plurality of landings, and an elevator drive, which is configured for moving the elevator car. The elevator system may further include a counterweight moving concurrently and in opposite direction with respect to the elevator car.

In order to allow passengers to input commands for controlling the operation of the elevator system, an elevator system usually comprises a plurality of elevator control input devices including landing control panels located on each of the landings and elevator car control panels located within each of the elevator cars.

It is desirable to enhance the operability of the elevator system by providing improved elevator control input devices providing a more convenient user experience.

### SUMMARY

According to an exemplary embodiment of the invention, an elevator control input device comprises at least two sensors, which are configured for detecting the presence of an object within a vicinity of the respective sensor. Each sensor is further configured for detecting the distance between the detected object and the respective sensor. The elevator control input device is configured for triggering a first action, which is individually associated with the respective sensor, when the object is detected to be situated closer than a first distance but further away than a second distance, which is smaller than the first distance, from the respective sensor. The elevator control input device is further configured for triggering a second action, which is individually associated with the respective sensor, when the object is detected to be situated closer than the second distance from the respective sensor. For triggering the second action, the sensors do not need be touched by the object.

The detected object may be a part of a human body, such as a hand or a finger of a passenger. The detected object also may be a glove, a grocery bag, a briefcase, a key, a token, in particular an RFID token, a mobile phone or another item carried by the passenger. This gives the passenger much freedom in operating the elevator control input device. Exemplary embodiments of the invention also include an elevator controller comprising at least one elevator control input device according to an exemplary embodiment of the invention.

Exemplary embodiments of the invention further include an elevator system with at least one elevator car, which is configured for traveling within a hoistway between a plurality of landings, at least one elevator drive configured for driving the movement of the at least one elevator car, and an elevator controller comprising at least one elevator control input device according to an exemplary embodiment of the invention, which is configured for controlling the movement of the at least one elevator car.

An elevator control input device according to an exemplary embodiment of the invention allows passengers to input commands for controlling the elevator system without touching any parts of the elevator system. In consequence, the risk of distributing filth and infectious material, such as viruses and bacteria via the elevator control input device is considerably reduced. Further, the first action may include notifying the passenger in advance about the consequences of his actions, in particular the results of triggering the associated second action. The first action may also include giving guidance to the passenger on how to invoke the second action.

As a result, the risk of an accidental erroneous operation of the elevator system due to faulty inputs may be considerably reduced. As will be discussed in more detail further below, an elevator control input device according to an exemplary embodiment of the invention in particular may be used for improving the operability of the elevator system for visually impaired passengers.

A number of optional features are set out in the following. These features may be realized in particular embodiments, alone or in combination with any of the other features.

In an embodiment the first distance is a distance in the range of 8 cm to 12 cm, in particular a distance of 10 cm, and the second distance is a distance in the range of 1 cm to 5 cm, in particular a distance in the range of 2 cm to 3 cm. Such distances have been found advantageous for a convenient operation of the elevator system.

In order to reduce the risk of accidentally triggering the first and/or second actions, the elevator control input device may be configured for triggering the first action only when the object is detected to be situated closer than the first distance but further away than the second distance from the respective sensor for at least a predetermined first period of time and/or wherein the elevator control input device is configured for triggering the second action only when the object is detected to be situated closer than the second distance from the respective sensor for at least a predetermined second period of time.

The first and second periods of time may be equal. In another embodiment, the first period of time may differ from the second period of time.

The first and second periods of time may be in the range of 0.5 s to 1.0 s. Such periods of time have been found to be well suited for considerably reducing the risk of accidentally activating one of the first and second actions without unduly deteriorating the operability and user experience of the elevator system.

In an embodiment, at least one of the first and second actions includes activating a visual output in order to provide the passenger with a visual feedback. Providing a visual signal is in particular advantageous for hearing-impaired passengers.

Light source(s) configured for generating the visual output may be arranged within or close to the sensor and/or the elevator control input device. Alternatively, light source(s) configured for generating the visual output may be arranged in some distance from the elevator control input device within the elevator car or at one of the landings. The light source(s) may be or may include at least one LED. The light source(s) may include light sources emitting light having different colors.

In an embodiment, the first action includes activating a first visual output and/or the second action includes activating a second visual output. The brightness and/or colors of the first and second visual outputs may be equal or different. The first and second visual outputs may be emitted by the same light source, which is selectively operated in different modes of operation, or by selectively activating different light sources.

In an embodiment, at least one of the first and second actions includes issuing an acoustic signal in order to provide the passenger with an acoustic feedback.

Providing an acoustic signal is in particular advantageous for visually impaired passengers.

In an embodiment, the acoustic signal includes a tone, a tone sequence and/or a voice message.

In an embodiment, the first action includes issuing a first acoustic signal and/or the second action includes issuing a second acoustic signal. The first and second acoustic signals may include different voice messages. Alternatively or additionally, the first and second signals may include tones having different volumes and/or pitches.

In an embodiment, at least one of the first and second actions includes activating a vibrating device in order to provide a tactile feedback to the passenger. The first action in particular may include causing the vibrating device to vibrate with a first frequency and with a first amplitude, and the second action in particular may include causing the vibrating device to vibrate with a second frequency and with a second amplitude, respectively.

The first and second frequencies may be equal or different. The first and second amplitudes may be equal or different as well.

Thus, triggering the first action may cause outputting a first audio signal (e.g. outputting at least one tone having a first pitch and/or a first vocal message), a first visual signal (e.g. activating a light having a first color), and/or a first tactile signal (e.g. activating the vibrating device to vibrate with a first frequency), or any combination thereof.

Similarly, triggering the second action may cause outputting a second audio signal (e.g. outputting at least one tone having a second pitch and/or a second vocal message), a second visual signal (e.g. activating a light having a second color), and/or a second tactile signal (e.g. activating the vibrating device to vibrate with a second frequency), or any combination thereof.

In an embodiment, triggering the first action may include activating a visual output, an acoustic signal and/or a vibration of the vibrating device, and triggering the second action may include deactivating the visual output, the acoustic signal and/or a vibration of the vibrating device.

In an embodiment, the elevator control input device is configured for providing a plurality of different signals depending on the detected distance between the part of the human body and the respective sensor, and/or the elevator control input device is configured for providing a continuously changing signal as a function of the detected distance between the part of the human body and the respective sensor.

For example, the brightness and/or color of a visual output may vary as a function of the distance between the detected object and the sensor. The brightness and/or color in particular may change in stages or continuously as a function of the distance between the detected object and the sensor.

Similarly, the volumes and/or pitches of at least one tone output by the elevator control input device may vary as a function of the distance between the detected object and the sensor. The volumes and/or pitches may change in stages or continuously as a function of the distance between the detected object and the sensor.

Such a configuration allows a passenger to determine the distance between the detected object controlled by the passenger and the sensor based on the visual and/or acoustic feedback provided by the elevator control input device. As a result, the operability and user experience may be further enhanced.

In an embodiment, the elevator control input device is an elevator car operation panel configured to be installed in an elevator car.

In another embodiment, the elevator control input device is a landing control panel configured to be installed in a landing area of an elevator system.

The landing control panel may comprise direction call sensors, in particular sensors with an arrow indicator, which allows inputting elevator service requests for traveling in an indicated direction, i.e. upwards or downwards.

Alternatively or additionally, the landing control panel may comprise floor selection sensors with alphanumerical indicators thereon that provide information about a destination and enable to make elevator service requests to travel to a specific destination landing.

The elevator control input device also may include a display, which allows dynamically changing the layout of the of elevator control input device. For example, additional functionalities may be shown on the display and associated with at least one of the sensors when the elevator system is operated in a special mode of operation, such as a maintenance mode and/or a VIP mode; and/or landings, which are temporarily closed and not accessible, may not be shown on the display.

When the object is detected in a position which is located closer than the first or second distances from more than one sensor, the elevator control input device may be configured for triggering the respective action associated with the sensor which detected the object first, or the elevator control input device may be configured for triggering the respective action associated with the sensor which is closest to the detected object.

Alternatively, the elevator control input device may be configured for triggering none of the first and second actions associated with the respective sensors, when the object is detected in a position which is located closer than the first or second distances from more than one of the sensors. Instead, the elevator control input device may be configured for triggering a third action indicating that the input provided by the object is inconclusive as the object has been detected in the vicinity of more than one of the sensors, and requesting the passenger to move the object closer to one of the sensors.

The third action may include simultaneously illuminating the respective sensors, in particular illuminating the respective sensors with a third color, for example red color. Alternatively or additionally, the third action may include issuing an acoustic error message or tone and/or displaying a visual error message on the display and/or activating the vibrating device to vibrate with a third frequency and with a third amplitude.

### DRAWING DESCRIPTION

In the following, an exemplary embodiment of the invention is described in more detail with respect to the enclosed figures. The illustrative arrangements depicted in the figures are not intended to be limiting, but rather are provided for illustrative and explanatory purposes.

FIG. 1 schematically depicts an elevator system according to an exemplary embodiment of the invention.

FIG. 2 depicts an enlarged front view of an elevator control input device according to an exemplary embodiment of the invention.

FIG. 3 depicts a sectional side view of the elevator control input device depicted in FIG. 2.

### DETAILED DESCRIPTION

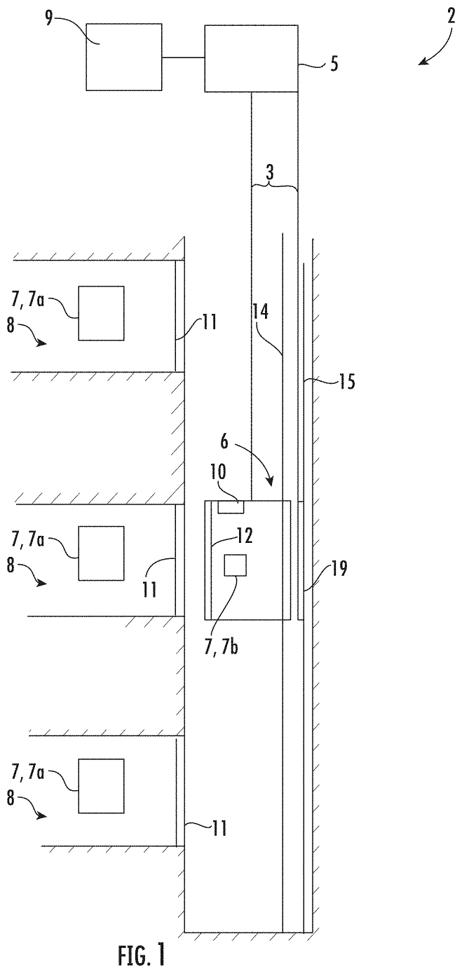

FIG. 1 schematically depicts an elevator system 2 according to an exemplary embodiment of the invention.

The elevator system 2 includes an elevator car 6 movably arranged within a hoistway 4 extending between a plurality of landings 8. The elevator car 6 in particular is movable in a longitudinal (vertical) direction along a plurality of car guide members 14, such as guide rails, extending along the vertical direction of the hoistway 4. Only one of said car guide members 14 is depicted in FIG. 1.

Although only one elevator car 6 is depicted in FIG. 1, exemplary embodiments of the invention may also include elevator systems 2 comprising a plurality of elevator cars 6 moving in one or more hoistways 4.

The elevator car 6 is movably suspended by means of a driving member (tension member) 3. The driving member 3, for example a rope or belt, is connected to an elevator drive 5, which is configured for driving the driving member 3 in order to move the elevator car 6 along the height of the hoistway 4 between the plurality of landings 8, which are located on different floors.

Details of the roping configuration are not specified in FIG. 1. The skilled person understands that the type of the roping is not essential for the invention and that different kinds of roping, such as a 1:1 roping, a 2:1 roping or a 4:1 roping may be employed.

The driving member 3 may be a rope, e.g. a steel wire rope, or a belt. The driving member 3 may be uncoated or may have a coating, e.g. in the form of a polymer jacket. In a particular embodiment, the driving member 3 may be a belt comprising a plurality of polymer coated steel cords (not shown). The elevator system 2 may have a traction drive including a traction sheave for driving the driving member 3. In an alternative configuration, which is not shown in the figures, the elevator system 2 may be an elevator system 2 without a driving member 3.

The elevator system 2 also may comprise e.g. a hydraulic drive or a linear drive. The elevator system 2 may have a machine room (not shown) or it may be a machine room-less elevator system 2.

The elevator system 2 further includes a counterweight 19 attached to the driving member 3 and configured for moving concurrently and in opposite direction with respect to the elevator car 6 along at least one counterweight guide member 15. The skilled person understands that the invention similarly may be applied to elevator systems 2 which do not comprise a counterweight 19.

Each landing 8 is provided with a landing door 11. The elevator car 6 is provided with at least one corresponding elevator car door 12 allowing passengers to transfer between a landing 8 and the interior of the elevator car 6 when the elevator car 6 is positioned at the respective landing 8.

At least one cabin light 10 is provided within the elevator car 6 for illuminating the interior space of the elevator car 6.

The elevator drive 5 is controlled by an elevator controller 9 for moving the elevator car 6 along the hoistway 4 between the different landings 8.

Input to the elevator controller 9 may be provided via elevator control input devices 7, in particular via landing control panels 7a provided on each of the landings 8, and/or via an elevator car control panel 7b provided inside the elevator car 6.

The elevator control input devices 7 may be connected to the elevator controller 9 by means of electric wires, which are not shown in FIG. 1, in particular by an electric bus, or by means of wireless data connections.

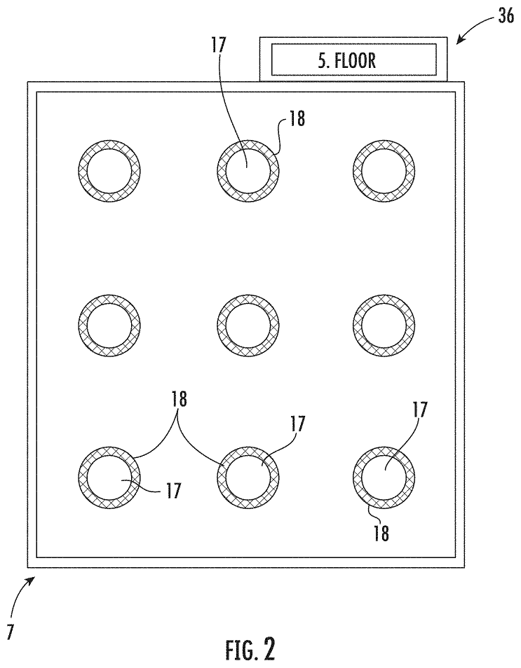

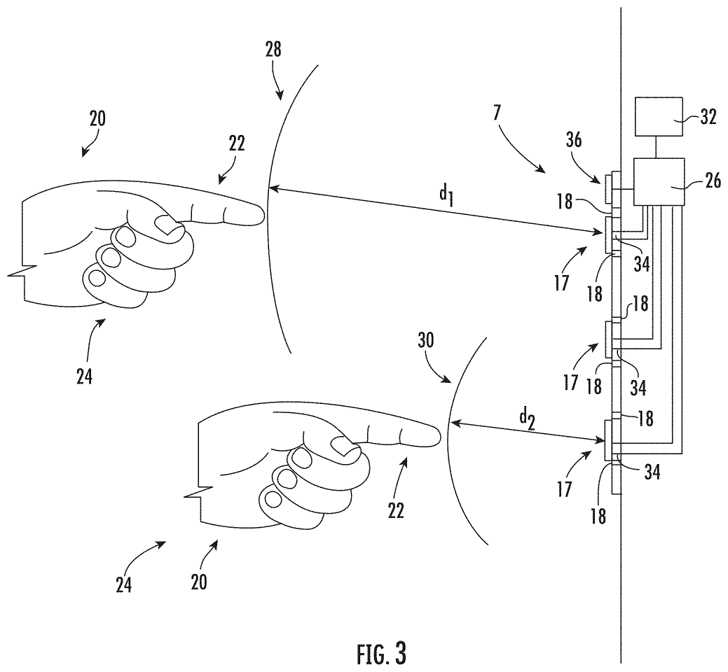

FIG. 2 depicts an enlarged front view of an elevator control input device 7 according to an exemplary embodiment of the invention, and FIG. 3 depicts a sectional side view thereof. The elevator control input device 7 depicted in FIGS. 2 and 3 may be employed as a landing control panel 7a or as an elevator car control panel 7b, respectively.

The elevator control input device 7 comprises a plurality of sensors 17, which are configured for detecting the presence of an object 24 (see FIG. 3), in particular a part of a human body, such as a hand 20 or a finger 22, in the vicinity of the respective sensor 17. Each sensor 17 is further configured for detecting the distance between the detected object 24 and the respective sensor 17.

In the embodiment depicted in FIG. 2, nine sensors 17 are arranged in a rectangular, in particular quadratic, 3×3-matrix configuration. This configuration, however, is only an exemplary configuration and the skilled person understands that the elevator control input device 7 may comprise more or less than nine sensors 17 which may be arranged in arbitrary configurations.

The elevator control input device 7 further comprises a controller 26, which is electrically connected with the plurality of sensors 17 for receiving detection signals from said sensors 17.

The controller 26 is further configured for triggering a first action, which is individually associated with the respective sensor 17, when an object 24 is detected to be situated closer than a first distance d₁ but further away than a second distance d₂, which is smaller than the first distance d₁, from the respective sensor 17.

The controller 26 is also configured for triggering a second action, which is individually associated with the respective sensor 17, when the object 24 is detected to be situated closer than the second distance d₂ from the respective sensor 17. For triggering the second action, the object 24 does not need to touch the sensor 17.

Thus, the sensors 17 replace the push buttons employed in conventional elevator control panels for allowing passengers to input control commands to the elevator system 2.

In a further embodiment, which is not explicitly depicted in the figures, the sensors 17 may be combined with push buttons or integrated into push buttons in order to additionally allow for a conventional input of control commands via the elevator control input device 7 by pressing the push buttons. Providing additional push buttons allows operating the elevator system 2 in case of a malfunction of the sensors 17 and/or in case the functionality of the sensors 17 is disturbed by adverse ambient conditions.

The first distance d₁ may be a distance in the range of 8 cm to 12 cm, in particular a distance of 10 cm, and the second distance d₂ may be a distance in the range of 1 cm to 5 cm, in particular a distance in the range of 2 cm to 3 cm.

In order to avoid accidentally triggering the first and/or second actions, the controller 26 of the elevator control input device 7 may be configured for activating the respective action only if the object 24 is detected within the respective spatial area 28, 30 for at least a predetermined amount of time, e.g. for at least 0.5 s to 1, 5 s, in particular for at least 1.0 s.

Triggering first and second actions, which are individually associated with the respective sensor 17, as a function of detecting the object 24 in at least two different spatial areas 28, 30 extending from the respective sensor 17 allows enhancing the operability and user experience of the elevator system 2 by adding additional functionalities to the elevator control input device 7.

The controller 26, for example, may comprise or may be connected to an audio output device 32, which is configured for outputting audio signals.

In an embodiment, the controller 26 and the audio output device 32 are configured for outputting audio signals including information about the functionalities/actions associated with a sensor 17, when the object 24 is detected within the first spatial area 28 associated with said sensor 17.

For example, when the second action associated with the sensor 17 is related to selecting a destination landing 8 for the elevator car 6, the audio signal, which is output as a first action when the object 24 is detected within the first spatial area 28 associated with one of the sensors 17, may be a vocal message (announcement) indicating that the passenger is going to select a destination landing 8 associated with said sensor 17 (“You are going to select floor number 5.”) if the object 24 is moved closer to the respective sensor 17. When the object 24 is moved into the second spatial area 30 of said sensor 17, the respectively associated destination landing 8 is selected (second action). Additionally and optionally, the second action may include outputting a second audio signal/vocal message (announcement) confirming the selection (“You selected floor number 5.”).

Instead of or in addition to a vocal message one or more tones may be output. The pitch and/or the volume of the tones may change as a function of the distance between the object 24 and the respective sensor 17. The pitch and/or the volume in particular may change in one, two or more steps, or it may change continuously as a function of the distance between the detected object 24 and the respective sensor 17.

Alternatively or in addition to outputting acoustic signals, triggering the first and/or second actions may include activating visual signals associated with the respective action.

For example, each sensor 17 may include a light 18 or may be associated with a corresponding light 18. Said light 18 may be or include at least one LED.

In the embodiment depicted in FIG. 2, the lights 18 are realized as illuminatable rings surrounding the associated sensor 17. In an alternative embodiment, which is not depicted in the figures, the lights 18 may be provided inside, in particular at the center, of the sensors 17, or the lights 18 may be located next to the respectively associated sensor 17.

The lights 18 may be configured for selectively emitting light having different colors, and the controller 26 may be configured for controlling a light 18 to emit light of a first color, when the first action is triggered, and for controlling the same light 18 to emit light of a second color, when the second action is triggered. Alternatively or additionally, the brightness of the respective light 18 may be changed as well.

Triggering the first and second actions also may include activating different lights 18.

In an embodiment, the lights 18 may be arranged in some distance from the elevator control input device 7. The controller, for example, may be coupled with a cabin light 10 of the elevator car 6 and configured for switching the color and/or the brightness of said cabin light 10 when the first and/or second action is triggered.

The lights 18 also may be provided as lights 18, in particular as light strips, within the elevator car 6 or above or next to the landing doors 11, respectively.

Activating visual signals may also include displaying written or graphical messages associated with the triggered action on a display 36 provided within the elevator car 6 and/or at the landings 8.

Additionally or alternatively, the sensors 17 may be equipped with vibrating devices 34, which may be activated by the controller 26 when the first and/or second actions are triggered. The vibrating devices 34 may by driven by the controller 26 to vibrate with different amplitudes and/or with different frequencies depending on the detected distance between the object 24 and the respective sensor 17. In a further embodiment, triggering the first action may include that the vibrating device 34 starts vibrating, and triggering the second action may include that the vibrating device 34 stops vibrating.

Audio signals output by the audio output device 32, visual signals provided by the lights 18 and tactile signals provided by the vibrating devices 34 may be arbitrarily combined with each other.

In other words, triggering the first action may result in outputting a first audio signal (e.g. outputting a tone having a first pitch and/or a first vocal message), a first visual signal (e.g. activating a light having a first color), and/or a first tactile signal (e.g. activating the vibrating device 34 to vibrate with a first frequency) or any combination thereof.

Similarly, triggering the second action may result in outputting a second audio signal (e.g. outputting a tone having a second pitch and/or a second vocal message), a second visual signal (e.g. activating a light having a second color), and/or a second tactile signal (e.g. activating the vibrating device 34 to vibrate with a second frequency) or any combination thereof.

An elevator control input device 7 according to an exemplary embodiment of the invention, for example, may be employed for assisting a visually impaired or even blind passenger in controlling the elevator system 2.

If, in an elevator system 2 according to such an embodiment, a hand 20 or finger 22 of a passenger approaches one of the sensors 17 so that the distance between the passenger's hand 20 or finger 22 and the respective sensor 17 becomes smaller than a first predetermined distance d₁ (see FIG. 3), a first vocal message indicating a function associated with the respective sensor 17 (e.g. “You are going to select the fifth floor.”) is output by the audio output device 32. Simultaneously a light 18 associated with the respective sensor 17 may light up in a first color and/or the cabin light 10 may change to a first cabin light color and/or the vibrating device 34 associated with the respective sensor 17 may vibrate with a first frequency.

If the hand 20 or finger 22 of the passenger approaches the same sensors 17 even further, so that the distance between the passenger's hand 20 or finger 22 becomes smaller than a second predetermined distance d₂, the landing 8 associated with said sensor 17 is selected as a destination for the elevator car 6. Additionally, a second vocal message confirming said selection (e.g. “You selected the fifth floor.”) is output by the audio output device 32. Simultaneously the light 18 associated with the respective sensor 17 may light up in a second color and/or the cabin light 10 may change to a second cabin light color and/or the vibrating device 34 associated with the respective sensor 17 may vibrate with a second frequency or the vibration of the vibrating device 34 may be switched off.

In further embodiments, the second action triggered by the elevator control input device 7 may include other actions than selecting a destination landing 8 of the elevator car 6. The second action triggered by the elevator control input device 7 for example may include opening or closing an elevator car door 12 and/or opening or closing a landing door 11. The second action may also include activating a maintenance mode or a VIP mode of the elevator system 2 providing additional functionalities.

If the elevator control input device includes a display 36, the layout of the of elevator control input device 7 may change in order to display the additional functionalities. Similarly, landings, which are temporarily closed and therefore not accessible, may not be shown on the display 36.

When the object 24 is detected in a position which is located closer than the first or second distances d₁, d₂, from more than one sensor 17, the elevator control input device 7 may be configured for triggering the respective action associated with the sensor 17 which detected the object 24 first, or the elevator control input device 7 may be configured for triggering the respective action associated with the sensor 17 which is closest to the detected object 24.

Alternatively, the elevator control input device may be configured for triggering none of the actions associated with the respective sensors 17, when the object 24 is detected in a position which is located closer than the first or second distances d₁, d₂ from more than one sensor 17. Instead, the elevator control input device 7 may be configured for triggering a third action indicating that the input provided by the object 24 is inconclusive as the object 24 has been detected in the vicinity of more than one of the sensors 17, and requesting the passenger to move the object 24 closer to one of the sensors 17.

The third action may include simultaneously illuminating the respective sensors 17 with a third color, for example with red color. Alternatively or additionally, the third action may include issuing an acoustic error message or tone and/or displaying a visual error message on the display 36 and/or activating one of the vibrating devices 34 to vibrate with a third frequency and with a third amplitude.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system
3 driving member
5 4 hoistway
5 elevator drive
6 elevator car
7 elevator control input
device 7a landing control panel
7b elevator car control panel
8 landing
9 elevator controller
10 cabin light
11 landing door
12 elevator car door
14 car guide member
15 counterweight guide member
17 sensor
18 light
19 counterweight
20 hand
22 finger
24 object
26 controller
28 first spatial area
30 second spatial area
32 audio output device
34 vibrating device
36 display

What is claimed is:

1. Elevator control input device comprising at least two sensors which are configured for detecting the presence of an object, in particular a part of a human body such as a hand or a finger, within a vicinity of the respective sensor;
wherein each sensor is further configured for detecting the distance between the detected object and the respective sensor; and
wherein the elevator control input device is configured for:
triggering a first action individually associated with the respective sensor when the object is detected to be situated closer than a first distance (d₁) but further away than a second distance (d₂) from the respective sensor; and for
triggering a second action individually associated with the respective sensor when the object is detected to be situated closer than the second distance (d₂) from the respective sensor.

2. Elevator control input device according to claim 1, wherein the first distance (d₁) is a distance in the range of 8 cm to 12 cm, in particular a distance of 10 cm, and/or wherein the second distance (d₂) is a distance in the range of 1 cm to 5 cm, in particular a distance in the range of 2 cm to 3 cm.

3. Elevator control input device according to claim 1, wherein the elevator control input device is configured for triggering the first action only when the object is detected to be situated closer than the first distance (d₁) but further away than the second (d₂) distance from the respective sensor for at least a predetermined first period of time and/or wherein the elevator control input device is configured for triggering the second action only when the object is detected to be situated closer than the second distance (d₂) from the respective sensor for at least a predetermined second period of time.

4. Elevator control input device according to claim 1, wherein the elevator control input device is configured for triggering a third action if the object is detected to be situated closer than the first distance (d₁) or closer than the second distance (d₂) from at least two of the sensors.

5. Elevator control input device according to claim 1, wherein at least one of the first, second, and third actions includes activating a visual output, in particular a visual output within an elevator car.

6. Elevator control input device according to claim 5, wherein the first action includes activating a first visual output and/or wherein the second action includes activating a second visual output and/or wherein the third action includes activating a second third output.

7. Elevator control input device according to claim 1, wherein at least one of the first, second, and third actions includes issuing an acoustic signal, wherein the acoustic signal in particular includes at least one tone and/or a voice message.

8. Elevator control input device according to claim 7, wherein the first action includes issuing a first acoustic signal and/or wherein the second action includes issuing a second acoustic signal and/or wherein the third action includes issuing a third acoustic signal.

9. Elevator control input device according to claim 1, wherein at least one of the first, second and third actions includes activating a vibrating device, wherein the first action in particular includes causing the vibrating device to vibrate with a first frequency and with a first amplitude, wherein the second action in particular includes causing the vibrating device to vibrate with a second frequency and with a second amplitude, and wherein the third action in particular includes causing the vibrating device to vibrate with a third frequency and with a third amplitude.

10. Elevator control input device according to claim 1, wherein the second action includes issuing at least one control signal to an elevator controller, wherein the at least one control signal in particular includes an elevator car destination signal and/or a door control signal.

11. Elevator control input device according to claim 1, wherein the elevator control input device is configured for providing a plurality of different signals depending on the detected distance between the object and the respective sensor, and/or wherein the elevator control input device is configured for providing a continuously changing signal as a function of the detected distance between the object and the respective sensor.

12. Elevator control input device according to claim 11, wherein elevator control input device is configured for changing the brightness and/or the color of a visual signal depending on the detected distance between the object and the respective sensor, and/or wherein the elevator control input device is configured for changing the pitch and/or the volume of an acoustic signal depending on the detected distance between the object and the respective sensor.

13. Elevator control input device according to claim 1, wherein the elevator control input device is a landing control panel configured to be installed at a landing of an elevator system, or an elevator car operation panel configured to be installed in an elevator car, wherein the elevator control input device in particular is configured for upwards/downwards dispatching and/or for destination dispatching of at least one elevator car.

14. Elevator control system comprising at least one elevator control input device according to claim 1.

15. Elevator system comprising at least one elevator car, which is configured for traveling within a hoistway between a plurality of landings, at least one elevator drive configured for driving the movement of the at least one elevator car, and an elevator controller according to claim 14, which is configured for controlling the movement of the at least one elevator car.
